(19) United States
(12) Patent Application Publication
(10) Pub. No.: US 2010/0154329 A1
(43) Pub. Date: Jun. 24, 2010

(54) WINDOW ASSEMBLY INCLUDING SEALANT BLOCKS

(76) Inventors: Herbert S. Adkins, Vienna, MO (US); Curtis J. Weavers, Argyle, MO (US)

Correspondence Address: Patent Docket Department;Armstrong Teasdale LLP, One Metropolitan Square, Suite 2600, St. Louis, MO, 63102-2740, US

(21) Appl. No.: 12/343,699

(22) Filed: Dec. 24, 2008

(51) Int. Cl. E06B 1/36; E06B 1/70; E04B 1/66

(52) U.S. Cl. 52/204.1; 52/204.5; 52/741.4; 52/745.15

(57) ABSTRACT

A window assembly that includes a window frame is described. The window frame includes, in an exemplary embodiment, a plurality of frame members joined together at joints to form the frame, and a plurality of sealant blocks, with one sealant block positioned at each of the joints. Each sealant block includes an inner surface, an outer surface, an upper surface and a lower surface. The sealant block also includes a set-back ledge in the inner surface extending the length of the sealant block adjacent one of the upper surface or the lower surface. The set-back ledge is defined by a recessed portion of the inner surface and a recessed portion of the upper surface or a recessed portion of the lower surface. The sealant block further includes a plurality of filler holes extending through the sealant block from the outer surface to the recessed portion of the inner surface.

### BACKGROUND OF THE INVENTION

The field of the invention relates generally to window assemblies, and more particularly to a window assembly that includes sealant blocks that provide for a water tight seal.

In a typical window assembly the window frame corners are either welded of mechanically fastened to provide a closed joint. In window assemblies having mechanically fastened frame corners, gaskets or applied sealants are used to seal the joints. Sealant can be applied during the manufacturing process with a caulk gun or other apparatus to the window frame joint area. Due to irregular configurations of window frame jambs, headers and sills, it is difficult to effectively seal the corner joints properly with applied sealants.

If an applied sealant does not completely and adequately seal the corner joints of window frames, water can migrate through the frame corner joints. American Architectural Manufacturers Association (AAMA) standards specify that water entry through the window frame is not acceptable. It would be desirable to provide window assemblies that include frame corner joints that are properly sealed and that meet AAMA standards in regard to water migration.

### BRIEF DESCRIPTION OF THE INVENTION

In one aspect, a window assembly that includes a window frame is provided. The window frame includes a plurality of frame members joined together at joints to form the frame, and a plurality of sealant blocks, with one sealant block positioned at each of the joints. Each sealant block includes an inner surface, an outer surface, an upper surface and a lower surface. The sealant block also includes a set-back ledge in the inner surface extending the length of the sealant block adjacent one of the upper surface or the lower surface of the sealant block. The set-back ledge is defined by a recessed portion of the inner surface of the sealant block and a recessed portion of the upper surface or a recessed portion of the lower surface of the sealant block. The sealant block further includes a plurality of filler holes extending through the sealant block from the outer surface to the recessed portion of the inner surface.

In another aspect, a sealant block for sealing joints of a window frame assembly formed from a plurality of window frame members is provided. The sealant block includes an inner surface, an outer surface, an upper surface and a lower surface. The sealant block also includes a set-back ledge in the inner surface extending the length of the sealant block adjacent one of the upper surface or the lower surface of the sealant block. The set-back ledge is defined by a recessed portion of the inner surface of the sealant block and a recessed portion of the upper surface or a recessed portion of the lower surface of the sealant block. The sealant block further includes a plurality of filler holes extending through the sealant block from the outer surface to the recessed portion of the inner surface,

In another aspect, a method of making a window assembly that includes a window frame is provided. The method includes joining a plurality of frame members together at joints between adjacent frame members to form the window frame, and positioning a sealant block at each joint. The sealant block includes an inner surface, an outer surface, an upper surface and a lower surface. The sealant block also includes a set-back ledge in the inner surface extending the length of the sealant block adjacent one of the upper surface or the lower surface of the sealant block. The set-back ledge is defined by a recessed portion of the inner surface of the sealant block and a recessed portion of the upper surface or a recessed portion of the lower surface of the sealant block. The sealant block further includes a plurality of filler holes extending through the sealant block from the outer surface to the recessed portion of the inner surface.

### BRIEF DESCRIPTION OF THE DRAWINGS

FIG. 1 is a perspective view of a window assembly in accordance with an embodiment of the present invention.

FIG. 2 is an enlarged view of area 2 shown in FIG. 1.

FIG. 3 is an inner perspective view of an upper sealant block shown in FIG. 1.

FIG. 4 is an outer perspective view of the upper sealant block shown in FIG. 3.

FIG. 5 is a top view of the upper sealant block shown in FIG. 3.

FIG. 6 is a top outer perspective view of a lower sealant block shown in FIG. 1.

FIG. 7 is a bottom inner perspective view of the lower sealant block seal shown in FIG. 6.

FIG. 8 is a top view of the lower sealant block shown in FIG. 6.

### DETAILED DESCRIPTION OF THE INVENTION

A window assembly that includes sealant blocks that provide improved sealing of window frame joints over known window assemblies is described below in detail. The sealant block is attached to the frame and includes a channel for uniform distribution of sealant to the window frame joints, regardless of the complexity or location of the joint. The sealant is directed into the channels, formed between the sealing block and the window frame, through filler holes in the sealing block. The sealant block provides for sealant coverage in the area to be sealed, and provides a pressurization of the sealant between the sealant block and the window frame to assist in the penetration of the sealant into the joints. In addition, the sealant blocks provide protection to the joints from shipping damage or mishandling.

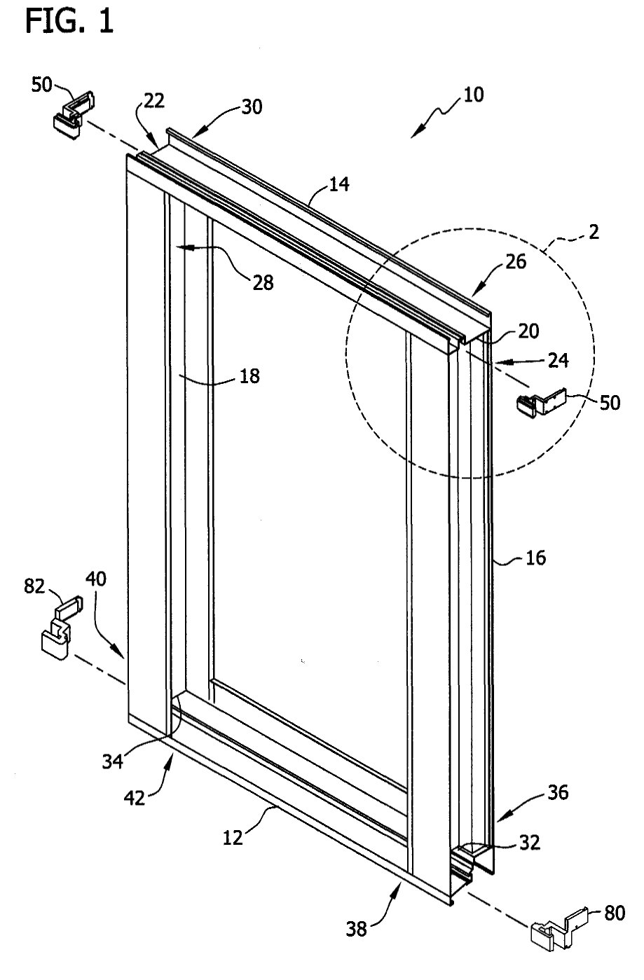

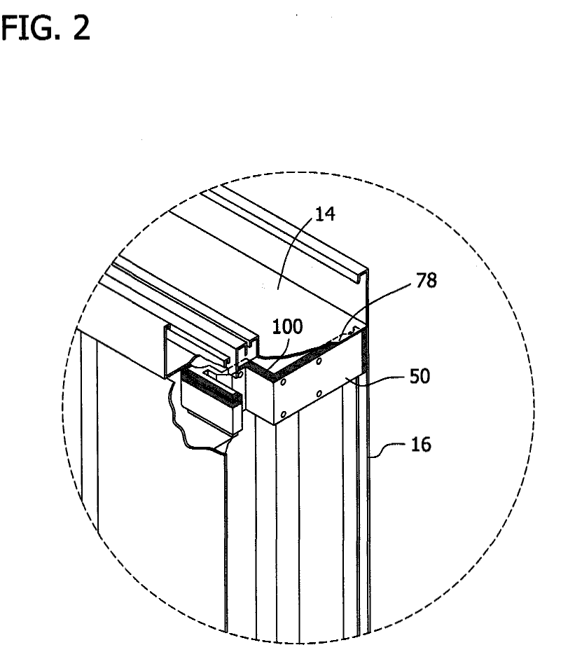

Referring to the drawings, FIG. 1 is a perspective view of a window assembly 10 in accordance with an exemplary embodiment of the present invention, and FIG. 2 is an enlarged view of area 2 shown in FIG. 1. Window assembly 10 includes a plurality of frame members. Particularly, in the exemplary embodiment, window assembly 10 includes a sill 12, a header 14, and jambs 16 and 18 extending between sill 12 and header 14. Joints 20 and 22 are formed between an upper end 24 of jamb 16 and a first end 26 of header 14, and between an upper end 28 of jamb 18 and a second end 30 of header 14 respectively. Joints 32 and 34 are formed between a lower end 36 of jamb 16 and a first end 38 of sill 12, and between a lower end 40 of jamb 18 and a second end 42 of sill 12 respectively.

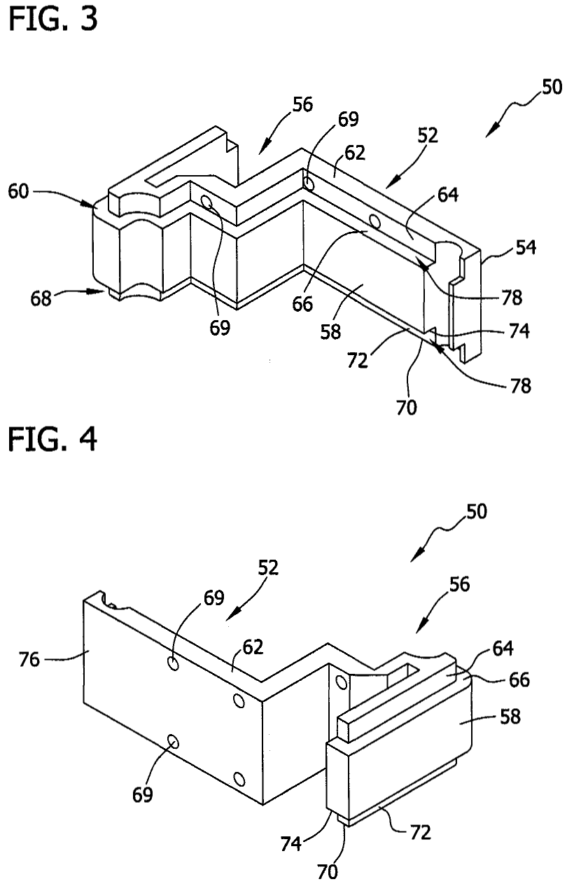

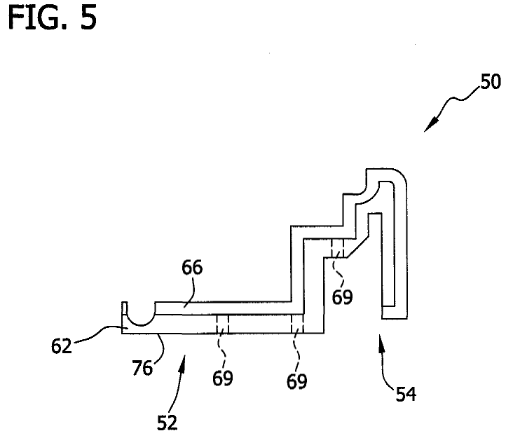

Upper sealant blocks 50 are positioned at joints 20 and 22. Sealant blocks 50 are configured to mirror the profile of window jambs 16 and 18. Sealant blocks 50 are attached to jambs 16 and 18 by a resistance fit with jambs 16 and 18. Referring also to FIGS. 3 and 4, upper sealant block 50 includes a first portion 52 extending from a first end 54 of upper sealant block 50 to a second portion 56 of upper sealant block 50. Second portion 56 has a substantially U-shaped cross section and includes a profile that matches the profile of jamb 16 or jamb 18 to permit a secure fit of upper sealant block 50 with jamb 16 or jamb 18 and which permits an inner surface 58 of upper sealant block 50 to be in direct contact with the outer surface of jamb 16 or jamb 18. Inner surface 58 of upper sealant block 50 includes a first set-back ledge 60 along the entire length of upper sealant block 50 adjacent an upper surface 62 of upper sealant block 50. First set-back ledge 60 is defined by a first recessed portion 64 of inner surface 58 and by a recessed portion 66 of upper surface 62 of upper sealant block 50. In the exemplary embodiment, inner surface 58 of upper sealant block 50 includes a second set-back ledge 68 along the entire length of upper sealant block 50 adjacent a lower surface 70 of upper sealant block 50. Second set-back ledge 68 is defined by a second recessed portion 72 of inner surface 58 and by a recessed portion 74 of lower surface 70 of upper sealant block 50. The first and second set-back ledges 60 and 68 permit upper sealant block 50 to be used on either side of window assembly 10 at either joint 20 or joint 22. At least one filler hole 69 extends through upper sealant block 50 from an outer surface 76 of upper sealant block 50 through first recessed portion 64 of inner surface 58 or through second recessed portion 72 of inner surface 58.

When upper sealant block 50 is positioned at joint 20 upper surface 62 of upper sealant block 50 contacts header 14 and inner surface 58 of upper sealant block 50 contacts the outer surface of jamb 20. A channel 78 is formed between first recessed portion 64 of inner surface 58, recessed portion 66 of upper surface 62 of upper sealant block 50, header 14 and jamb 20. When upper sealant block 50 is positioned at joint 22, lower surface 70 of upper sealant block 50 contacts header 14 and inner surface 58 of upper sealant block 50 contacts the outer surface of jamb 20. Channel 78 is formed between second recessed portion 72 of inner surface 58, recessed portion 74 of lower surface 70 of upper sealant block 50, header 14 and jamb 20.

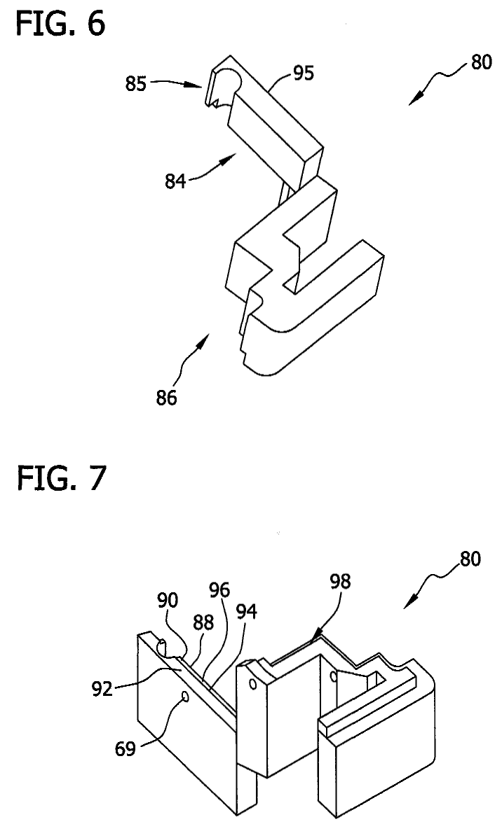

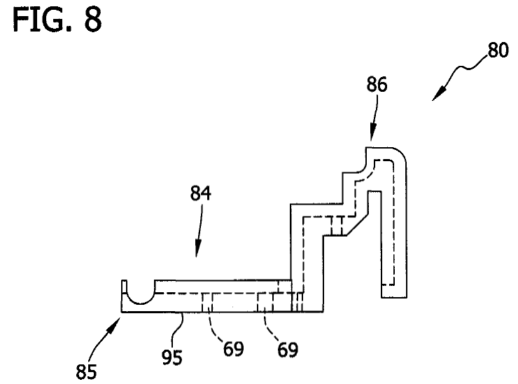

Referring also to FIGS. 6-8, lower sealant blocks 80 and 82 are positioned at joints 32 and 34 respectively. Sealant blocks 80 and 82 are configured to mirror the profile of window jambs 16 and 18 respectively and sill 12. Sealant blocks 80 and 82 are attached to jambs 16 and 18 respectively by a resistance fit with jambs 16 and 18. Lower sealant blocks 80 and 82 are mirror images of each other, and the following description of lower sealant block 80 also applies to lower sealant block 82.

Lower sealant block 80 (82) includes a first portion 84 extending from a first end 85 of lower sealant block 80 (82) to a second portion 86 of lower sealant block 80 (82). Second portion 86 is off-set from first portion 84 to follow the contour of the upper surface of sill 12. Second portion 86 has a substantially U-shaped cross section and includes a profile that matches the profile of jamb 16 to permit a secure fit of lower sealant block 80 (82) with jamb 16 and which permits an inner surface 88 of lower sealant block 80 (82) to be in direct contact with the outer surface of jamb 16 (18). Inner surface 88 of lower sealant block 80 includes a set-back ledge 90 along the entire length of lower sealant block 80 (82) adjacent a lower surface 92 of lower sealant block 80. Set-back ledge 90 is defined by a recessed portion 94 of inner surface 88 and by a recessed portion 96 of lower surface 92 of upper sealant block 80 (82). At least one filler hole 69 extends through lower sealant block 80 (82) from an outer surface 95 of lower sealant block 80 (82) through recessed portion 94 of inner surface 88.

When lower sealant block 80 is positioned at joint 32, lower surface 92 of lower sealant block 80 contacts sill 12 and inner surface 88 of lower sealant block 80 contacts the outer surface of jamb 16. A channel 98 is formed between recessed portion 94 of inner surface 88, recessed portion 96 of upper surface 92 of lower sealant block 80, sill 12 and jamb 16. When lower sealant block 82 is positioned at joint 34, lower surface 92 of lower sealant block 82 contacts sill 12 and inner surface 88 of lower sealant block 82 contacts the outer surface of jamb 18. Channel 98 is formed between recessed portion 94 of inner surface 88, recessed portion 96 of lower surface 92 of lower sealant block 80, sill 12 and jamb 18.

Sealant blocks 50, 80, and 82 can be formed from any suitable material. For example, sealant blocks 50, 80, and 82 can be formed from any suitable metal, such as steel, aluminum, titanium, and the like, or any suitable plastic material, such as thermoplastic materials and thermoset plastic materials.

To seal joints, 20 22, 32, and 34, an upper sealant block 50 is positioned adjacent seal joint 20 and in contact with header 14 and jamb 16, another upper sealant block 50 is positioned adjacent seal joint 22 and in contact with header 14 and jamb 18. In addition, lower sealant block 80 is positioned adjacent joint 32 and in contact with sill 12 and jamb 16, and lower sealant block 82 is positioned adjacent joint 34 and in contact with sill 12 and jamb 18. A sealant 100 is applied through sealant filler holes 68 of upper sealant blocks 50 and lower sealant blocks 80 and 82. Sealant 100 fills channels 78 of upper sealant blocks 50 and channels 98 of lower sealant blocks 80 and 82. Sealant 100 is forced into joints 20, 22, 32, and 34 by sealant pressure build-up in channels 68 and 98 to seal joints 20, 22, 32, and 34. Sealant 100 can be any suitable sealant material that is useful for sealing joints in a window assembly to prevent water migration through the joints.

While the invention has been described in terms of various specific embodiments, those skilled in the art will recognize that the invention can be practiced with modification within the spirit and scope of the claims.

What is claimed is:

1. A window assembly comprising a window frame, said window frame comprising:
a plurality of frame members joined together at joints to form said frame; and
a plurality of sealant blocks, one sealant block positioned at each of said joints, each said sealant block comprising:
an inner surface, an outer surface, an upper surface and a lower surface;
a set-back ledge in said inner surface extending a length of said sealant block adjacent one of said upper surface or said lower surface, said set-back ledge defined by a recessed portion of said inner surface and a recessed portion of said upper surface or a recessed portion of said lower surface; and
a plurality of filler holes extending through said sealant block from said outer surface to said recessed portion of said inner surface.

2. A window assembly in accordance with claim 1 wherein said sealant block inner surface having a profile that matches a profile of a surface of one of said frame members so that said inner surface of said sealant block is in direct contact with said surface of said window frame member

3. A window assembly in accordance with claim 1 wherein each said joint is located in a channel formed by said sealant block positioned at said joint and adjacent form members extending from said joint.

4. A window assembly in accordance with claim 3 wherein said channel is defined by said set-back ledge and a surface of one of said adjacent frame members and a surface of the other of said adjacent frame members.

5. A window assembly in accordance with claim 3 further comprising a sealant substantially filling said channel.

6. A window assembly in accordance with claim 1 wherein said sealant block comprises a first set-back ledge and a second set-back ledge extending said length of said sealant block, said first set-back ledge adjacent said upper surface of said sealant block, and said second set-back ledge adjacent said lower surface of said set-back ledge.

7. A window assembly in accordance with claim 1 wherein said plurality of frame members comprise:
a sill;
a header; and
a first and a second jamb extending between and joined to said sill and said header.

8. A sealant block for sealing joints of a window frame assembly formed from a plurality of window frame members, said sealant block comprising:
an inner surface, an outer surface, an upper surface and a lower surface;
a set-back ledge in said inner surface extending a length of said sealant block adjacent one of said upper surface or said lower surface, said set-back ledge defined by a recessed portion of said inner surface and a recessed portion of said upper surface or a recessed portion of said lower surface; and
a plurality of filler holes extending through said sealant block from said outer surface to said recessed portion of said inner surface.

9. A sealant block in accordance with claim 8 wherein said inner surface having a profile that matches a profile of a surface of one of the window frame members so that said inner surface of said sealant block can be positioned in direct contact with the surface of the window frame member.

10. A sealant block in accordance with claim 8 wherein said sealant block comprises a first set-back ledge and a second set-back ledge extending said length of said sealant block, said first set-back ledge adjacent said upper surface of said sealant block, and said second set-back ledge adjacent said lower surface of said set-back ledge.

11. A method of making a window assembly comprising a window frame, said method comprising:
joining a plurality of frame members together at joints between adjacent frame members to form the window frame; and
positioning a sealant block at each joint, the sealant block comprising:
an inner surface, an outer surface, an upper surface and a lower surface;
a set-back ledge in the inner surface extending a length of the sealant block adjacent one of the upper surface or the lower surface, the set-back ledge defined by a recessed portion of the inner surface and a recessed portion of the upper surface or a recessed portion of the lower surface; and
a plurality of filler holes extending through the sealant block from the outer surface to the recessed portion of the inner surface.

12. A method in accordance with claim 11 wherein positioning a sealant block at each joint comprises positioning a sealant block at each joint so that the joint is located in a channel formed by the sealant block and the adjacent form members joined at the joint.

13. A method in accordance with claim 12 wherein the channel is defined by the set-back ledge and a surface of one of the adjacent frame members and a surface of the other of the adjacent frame members.

14. A method in accordance with claim 12 further comprising applying sealant through the plurality of sealer holes to substantially filling the channel and seal the joint.

15. A method in accordance with claim 1 wherein the plurality of frame member comprise a sill, a header, a first jamb, and a second jamb, and joining a plurality of frame members together comprises:
joining a first end of the first jamb to the sill;
joining a first end of the second jamb to the sill;
joining a second end of the first jamb to the header; and
joining a second end of the second jamb to the header.
